(19) United States
(12) Patent Application Publication
(10) Pub. No.: US 2022/0089122 A1
(43) Pub. Date: Mar. 24, 2022

(54) SYSTEM FOR SYNCHRONIZING CUSTOMIZED USER PREFERENCES

(71) Applicant: Sumitomo Wiring Systems, Ltd., Yokkaichi-shi (JP)

(72) Inventor: Alexander Ginter, Farmington Hills, MI (US)

(21) Appl. No.: 17/031,093

(22) Filed: Sep. 24, 2020

(51) Int. Cl. B60R 25/24; B60R 25/01; G07C 9/00

(52) U.S. Cl. CPC B60R 25/241; G07C 2009/00515; G07C 9/00309; B60R 25/01

(57) ABSTRACT

A system for synchronizing user preferences in a vehicle having a locking mechanism, a first remote device including a first identifier associated with a first customized user preference, and a second remote device including a second identifier associated with a second customized user preference. The system includes a CPU, a detection unit, a checking unit, and a synchronization unit. The memory device is configured to store the first customized user preference and the second customized user preference. The detection unit is configured to determine a presence of the first identifier or the second identifier within the vehicle. The checking unit is configured to identify a change to the first customized user preference or the second customized user preference, and to store the change within the memory device. The synchronization unit is configured to synchronize the first and second customized user preferences to the change stored in the memory device.

### TECHNICAL FIELD

The present disclosure relates generally to a system for synchronizing customized user preferences across multiple remote devices.

### BACKGROUND

An automotive vehicle may have multiple remote devices for accessing the vehicle. Each of the remote devices may be associated with a customized user preference. The customized user preference is a setting programmed/selected by a user of a remote device. For instance, one remote device may have a customized user preference for a door lock that is set to an enabled-state while the other remote device may have a customized user preference for the door lock that is set to a disabled-state. Such a difference may create a problem for the users.

In one example, when a bed gate lock is in the enabled-state, the bed gate can be unlocked via a vehicle's key, or through controls within the vehicle. When the bed gate lock is in the disabled-state, the bed gate is always unlocked. When the bed gate lock is unlocked, the bed gate of the vehicle can manually be opened, thereby making the contents of the bed of the vehicle accessible.

A problematic scenario arises when a first driver has a remote device associated with a customized user preference wherein the bed gate is in the enabled-state and the second driver has a remote device associated with a customized user preference wherein the bed gate is in the disabled-state. Accordingly, when the first driver uses the vehicle, the bed gate lock is automatically set to an enabled-state. When the first driver stores a valuable item in the bed of the truck (e.g., a valuable painting), the first driver is confident that the valuable item is secured. In the event that the first driver leaves and the second driver uses his/her remote device to operate the vehicle, the vehicle automatically sets the bed gate lock to the disabled preference and thus the valuable item may now be easily stolen since the bed gate lock is unlocked.

Thus, there is a need for a system for synchronizing changed customized user preferences.

### SUMMARY

A system for synchronizing customized user preferences is provided. The system may be implemented in a vehicle having a locking mechanism, a first remote device including a first identifier associated with a first customized user preference, and a second remote device including a second identifier associated with a second customized user preference. The system may include a central processing unit (CPU), a detection unit, a checking unit, and a synchronization unit. The CPU is in communication with a non-volatile memory device configured to store the first customized user preference and the second customized user preference.

The detection unit is in communication with the CPU. The detection unit is configured to determine a presence of the first or second remote device within the vehicle and processes the identifier of the first or second remote device, as the case may be, to actuate a vehicle setting to a corresponding first or second customized preference. The checking unit may be in communication with the CPU. The checking unit may be configured to identify a change to a predetermined preference of the first customized user preference or the second customized user preference. The checking unit may be configured to store the change in the predetermined user preference within the memory device. The synchronization unit may be in communication with the CPU. The synchronization unit may be configured to synchronize the first and second customized user preferences to the change in the predetermined preference stored in the memory device.

Implementations of the disclosure may include one or more of the following optional features. In some implementations, the checking unit is configured to determine whether the change in the predetermined preference was made to the first customized user preference or the second customized user preference.

In some implementations, upon an occurrence of a reset condition, the synchronization unit sets the second customized user preference to the first customized user preference, if the first identifier is detected within the vehicle or sets the first customized user preference to the second customized user preference, if the second identifier is detected within the vehicle. The reset condition may occur when the vehicle loses power as a result of a battery being disconnected.

In some implementations, the memory device includes an electrically erasable programmable read-only memory (EEPROM).

In some implementations, the predetermined preference is the state of a locking mechanism, wherein the state may be an enabled-state or a disabled-state. Wherein in the enabled-state the locking mechanism may lock or unlock a bed gate of the vehicle.

In some implementations, the first and the second remote devices are configured to lock or unlock the bed gate of the vehicle when the locking mechanism is set in the enabled-state. The first and the second remote devices may be restricted from locking or unlocking the bed gate of the vehicle when the locking mechanism is set in the disabled-state.

Another aspect of the disclosure provides a system for synchronizing changed customized user preferences in a vehicle having a locking mechanism, a first remote device including a first identifier having a first customized user preference, and a second remote device including a second identifier having a second customized user preference. The system includes a CPU, a detection unit, a checking unit, and a synchronization unit. The CPU is in communication with a non-volatile memory device configured to store the first customized user preference and the second customized user preference.

The detection unit is in communication with the CPU. The detection unit may be configured to determine a presence of the first or second remote device within the vehicle and process the first identifier or the second identifier as the case may be. The checking unit is in communication with the CPU. The checking unit may be configured to identify a change to a predetermined user preference of the first customized user preference or the second customized user preference. The checking unit may be configured to store the change of the predetermined preference within the memory device. The synchronization unit may be in communication with the CPU. The synchronization unit may be configured to synchronize the first and second customized user preferences to the change in the predetermined preference stored in the memory device. In one aspect, the predetermined preference is an enabled-state or a disabled-state of the locking mechanism. In one aspect, the locking mechanism may be configured to lock or unlock a bed gate of the vehicle.

Implementations of this aspect of the disclosure may include one or more of the following optional features. In some implementations, the checking unit is configured to determine whether the change was made to the first customized user preference or the second customized user preference.

In some implementations, upon an occurrence of a reset condition, the synchronization unit sets the second customized user preference to the first customized user preference, if the first identifier is detected within the vehicle and sets the first customized user preference to the second customized user preference, if the second identifier is detected within the vehicle.

In some implementations, the reset condition occurs when the vehicle loses power.

In some implementations, the memory device includes electrically erasable programmable read-only memory (EEPROM).

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 is a schematic view of a system for synchronizing changed customized user preferences in accordance with the principles of the present disclosure;

FIG. 2 is a schematic view of operations performed by the system of FIG. 1;

FIG. 3 is a schematic view of operations performed by the system of FIG. 1; and

FIG. 4 is a schematic view of operations performed by the system of FIG. 1.

### DETAILED DESCRIPTION OF PREFERRED EMBODIMENTS

Referring generally to the figures, a system for synchronizing a change in a predetermined preference of a customized user preference across multiple remote devices is provided. The system may be implemented in an automotive vehicle having at least a pair of remote devices (e.g., key fobs) and a bed gate lock. The remote devices may be programmed to be associated with a customized user preference which sets the conditions of the automotive vehicle to a desired condition. One of the customized user preferences relates to an enabled or disabled operability of the bed gate lock. The system detects the presence of one of the pair of remote devices and determines if a change has been made to the predetermined preference of the customized user preference and synchronizes the user preference of the other remote device when a change has been made such that all the remote devices have the changed predetermined preference.

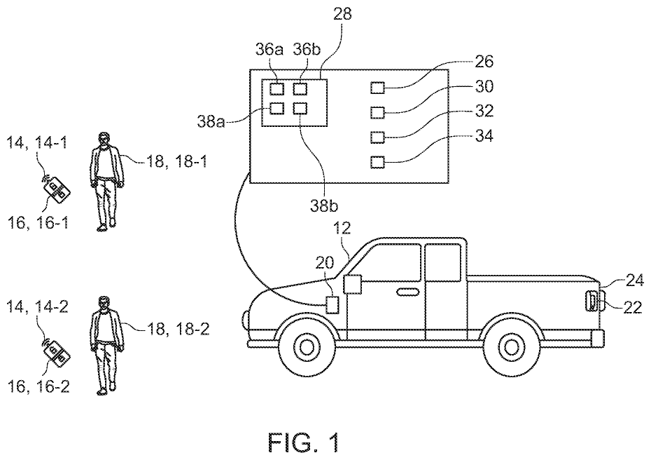

With reference first to FIG. 1, a system 10 for synchronizing changed customized user preferences is shown. In some configurations, the system 10 may be implemented in an automotive vehicle 12 having a first remote device 14-1 (e.g., a first key fob), a second remote device 14-2 (e.g., a second key fob). The vehicle 12 is illustratively shown as a truck, having a pair of side doors and a bed gate.

The first remote device 14-1 includes a first identifier 16-1 (e.g., a first key identifier). The second remote device 14-2 includes a second identifier 16-2 (e.g., a second key identifier). The first identifier 16-1 may be associated with a first driver 18-1. The second identifier 14-2 may be associated with a second driver 18-2. The first identifier 16-1 and the second identifier 16-2 are different from each other so as to distinguish the first remote device 14-1 from the second remote device 14-2. For illustrative purposes, the first and second remote devices 14-1, 14-2 are shown as being a standard key fob issued by the manufacturer, but may be other remote devices configured to interact with the vehicle 12, such as a smart phone, tablet or the like. The first and second remote devices 14-1, 14-2 include a wireless unit configured to transmit and receive a wireless signal, such as a radio frequency, the radio frequency carrying a respective first or second identifier 16-1, 16-2 as the case may be.

The first remote device 14-1 and the second remote device 14-2 may be programmed to be associated with a customized user preference. For example, the first driver 18-1 may program the customized user preference of the first remote device 14-1 to have the driver seat of the vehicle 12 disposed at a specific position relative to the pedals of the vehicle 12, or a certain locking mechanism (e.g., door locking mechanism, bed gate locking mechanism) set to a certain state, etc. Likewise, the second driver 18-2 may program the customized user preference of the second remote device 14-2. It should be appreciated that the customized user preferences may be completely identical or may be completely different from each other, but that they are based upon the preferences of a driver.

It should also be appreciated that the customized user preference may be programmed using a touch screen display panel, or an input such as a dial or button assembly disposed in a vehicle console, or both. Changes may be made to the customized user preference by standard features such as a drop down menu, voice command or the like. In another aspect, where the remote device is a smart phone or other mobile device, the customized user preferences may be customized using a software application. That is, the user may change a seat preference, or locking mechanism preference by manipulating the remote device. The first and second remote devices 14-1, 14-2 may be programmed with a standard user setting which may be changed by the driver so as to generate a customized user preference for a respective remote device 14-1 or 14-2 as the case may be. While the system 10 is generally shown and described herein as including two remote devices 14 and two drivers 18, it should be appreciated that the system 10 may include more than two remote devices 14 and drivers 18.

As discussed in greater detail below, the vehicle 12 is configured to detect a presence of the first remote device 14-1 and the second remote device 14-2. For instance, the vehicle 12 may be configured to recognize when the first identifier 16-1 is within the vehicle 12 or when the second identifier 16-2 is within the vehicle 12.

With continued reference to FIG. 1, the vehicle 12 may include a control module 20, a locking mechanism 22, and a bed gate 24. As will be discussed in more detail below, the control module 20 may include a central processing unit (CPU) 26, a memory device 28, a detection unit 30, a checking unit 32, and a synchronization unit 34. In some implementations, the control module 20 is an engine control unit (ECU), a door-locking control module, or a bed gate locking control module. The control module 20 may be disposed within the vehicle 12. It should be appreciated that the detection unit 30, the checking unit 32, and the synchronization unit 34 may a be a set of written instructions or logic that is realized in digital electronic and/or optical circuity, integrated circuity, specially designed ASICs (application specific integrated circuits), computer hardware, firmware, software, and/or combinations thereof. Further, the function of the detection unit 30, the checking unit 32, and the synchronization unit 34 can include implementation in one or more computer programs that are executable and/or interpretable in a programmable system including at least one programmable processor.

In some configurations, the locking mechanism 22 is a manual or an electronic lock. In particular, the locking mechanism 22 may be a servo lock or a rotary lock. The locking mechanism 22 may be configured to be in a first state or a second state. In particular, the locking mechanism 22 is configured to be in an enabled-state or a disabled-state. In some implementations, the locking mechanism 22 is mechanically coupled to the bed gate 24 of the vehicle 12 so as to lock or unlock the bed gate 24.

When the locking mechanism 22 is set in the enabled-state, the bed gate 24 may be locked and unlocked via a key to the vehicle 12, the remote device 14, or through the controls within in the vehicle 12. When the locking mechanism 22 is set to the disabled-state, the bed gate 24 is automatically moved to an unlocked position. While, the locking mechanism 22 is unlocked, the bed gate 24 may be manually opened without a key, thereby allowing the contents of the bed of vehicle 12 to be freely accessible.

As illustrated in FIG. 1, the control module 20 includes a CPU 26. The CPU 26 may be any suitable electronic processing device illustratively including a microcontroller, a microprocessor, an application specific integrated circuit (ASIC), or any other suitable processing device. The CPU 26 executes instructions that are stored within the memory device 28. For instance, the detection unit 30, the checking unit 32, and the synchronization unit 34 may be written instructions or a set of logic programming that are executed by the CPU 26. The CPU 26 is in communication with the memory device 28.

With continued reference to FIG. 1, the memory device 28 may include non-volatile memory. In some implementations, the memory device 28 includes an electrically erasable, programmable read-only memory (EEPROM). The memory device 28 may be configured to store instructions that are executed by the CPU 26. The memory device 28 is configured to store a first customized user preference 36 including a current first customized user preference 36a and a last known first customized user preference 36b, both of which are associated with the first driver 18-1. The current first customized user preference 36a is the current user preferences and last known first customized user preference 36b is the last known user preferences (e.g., the first driver's 18-1 previously set user preferences). Likewise, the memory device 28 is configured to store a current second customized user preference 38a and a last known second customized user preference 38b, both of which are associated with the second driver 18-2.

As described above, the first and second customized user preference 36a, 36b, 38a, 38b may include a plurality of vehicle settings, to include seat position, drive mode-e.g. sport, economy, steering wheel position and the like. In one instance, the predetermined preference is the state of the locking mechanism 22 of the bed gate 24, that is whether the locking mechanism 22 is in the enabled-state or the disabled-state. Thus, by storing a current preference and a last known preference, the system may determine if a change was made to a preference in the first or second customized user preference 36, 38.

The first and second remote devices 14-1, 14-2 are configured to lock or unlock the bed gate 24 of the vehicle 12 when the locking mechanism 22 is set in the enabled-state. However, the first and second remote devices 14-1, 14-2 are restricted from locking or unlocking the bed gate 24 of the vehicle 12 when the locking mechanism 22 is set in the disabled-state. The bed gate 24 of the vehicle 12 is defaulted to being unlocked while the locking mechanism 22 is set in the disabled-state.

The detection unit 30 is configured to detect the presence of the first or second remote devices 14-1, 14-2. In one aspect, the detection unit 30 may include a plurality of receivers disposed within the vehicle cabin. The detection unit 30 may be configured to process a signal strength of the first and second remote devices 14-1, 14-2 so as to detect a presence of the first or second remote device 14-1. 14-2. As an example, the receivers may be located adjacent the driver's seat thus in instances where both the first or second remote devices are detected, and the signal strength of the first remote 14-1 is greater than the second remote 14-2, the detection unit 30 determines that the first remote 14-1 is the driver and processes the first identifier 16-1. The vehicle 12 automatically sets the vehicle settings to the customized user preferences associated with the first remote device 14-1, when the detection unit 30 determines that the first driver 18-1 is the current driver.

For example, the vehicle 12 may automatically set the driver's seat to the first driver's 18-1 desired position, and the certain locking mechanisms to the state desired by the first driver 18-1, etc. Likewise, when the vehicle 12 recognizes that the second driver 18-2 is the current driver, the vehicle automatically sets the vehicle settings to the second driver's 18-2 customized user preferences. For example, the vehicle 12 may automatically set the driver's seat to the second driver's 18-2 desired position, and the certain locking mechanisms to the state desired by the second driver 18-2, etc.

The checking unit 32 is in communication with the CPU 26. In some configurations, the function of the checking unit 32 is executed by the CPU 26. The checking unit 32 may be configured to identify a change to the first customized user preference 36 or the second customized user preference 38. In this regard, to determine if a changed occurred to the first customized user preference 36, the checking unit 32 compares the value of the current first customized user preference 36a with that of the last known value of the first customized user preference 36b stored. For instance, the checking unit 32 determines a change in the first customized user preference 36 if the value of the current first customized user preference 36a, stored within the memory device 28, is different than the last known first customized user preference 36b, stored within the memory device 28. In particular, if the current first customized user preference 36a is set to an enabled-state, and the last known value of the first customized user preference 36b is set to a disabled-state, then a changed has occurred to the first customized user preference 36. Likewise, to determine if a change occurred to the second customized user preference 38, the checking unit 32 compares the value of the current second customized user preference 38a with that of the last known value of the second customized user preference 38b. As will be discussed in more detail below, in some examples, the checking unit 32 is configured to store the foregoing change within the memory device 28.

The synchronization unit 34 is in communication with the CPU 26. In some configurations, the function of the synchronization unit 34 is executed by the CPU 26. As will be discussed in greater detail below, the synchronization unit 34 may be configured to synchronize the first and second customized user preferences 36, 38 to the change stored within the memory device 28. In particular, a change in a predetermined preference, such as the locking mechanism 22, of the first or second customized user preferences 36, 38 is determined and the change made to one of the first or second customized user preferences 36, 38 is made to the other of the first or second customized user preferences 36, 38.

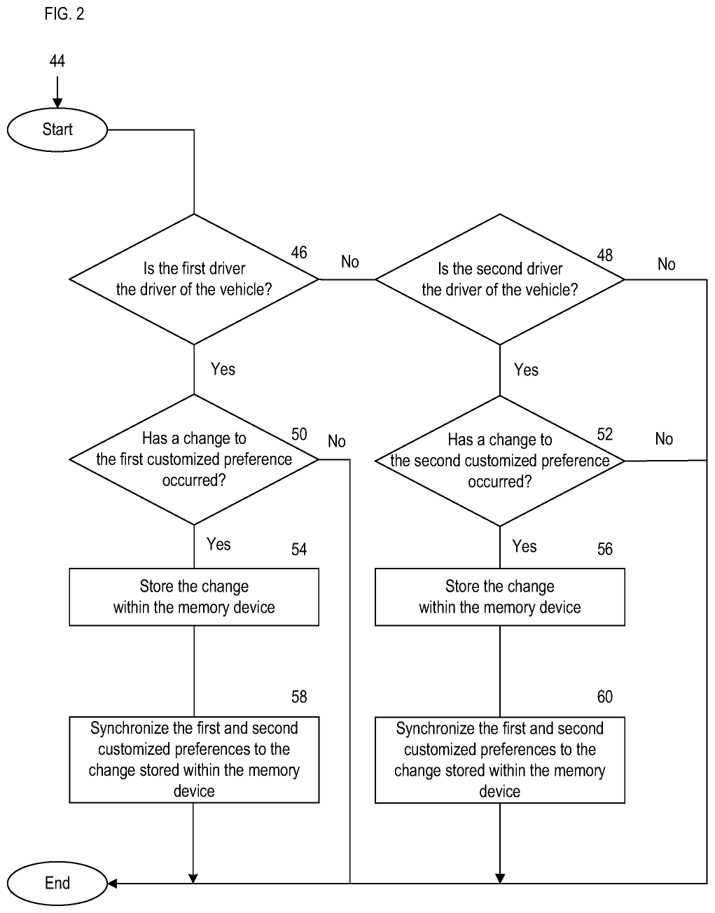

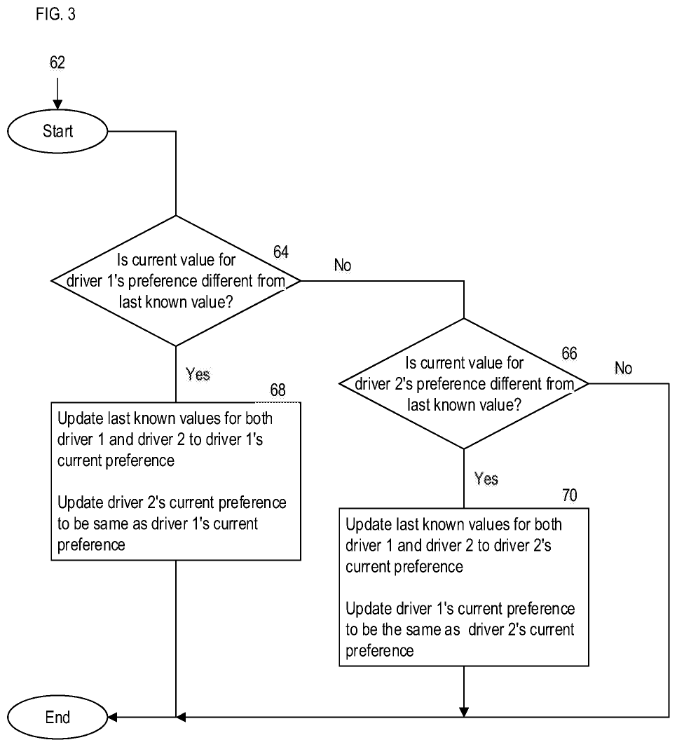

With reference to FIGS. 2 and 3, operations 44, 62 performed by the system 10 for synchronizing changed user preferences are shown. In particular, the operations may be directed toward synchronizing the changed customized user preference configured to set the locking mechanism 22 of the bed gate 24 in an enabled-state or a disabled-state.

For instance, a first driver 18-1 may desire to change the first customized preference 36 of the locking mechanism 22 from a disabled-state to an enabled-state. As mentioned above, the first driver 18-1 may change the first customized user preference 36 by using a touch screen display panel, or an input such as a dial or button assembly disposed in a vehicle console, or both. After the first driver 18-1 changes the first customized user preference 36 to the enabled-state, the system 10, by conducting the operations as set forth below, will automatically synchronize the second driver's 18-2 second customized user preference 38 to match the recently changed first customized user preference 36. In this regard, the second customized user preference 38 will also be set to the enabled-state.

As illustrated in FIG. 2, in some implementations, at block 46, the system 10 determines, by the detection unit 30, if the first driver 18-1 is the current driver of the vehicle 12. For instance, as set forth above, the detection unit 30 detects whether the first remote device 14-1 is within the vehicle 12. If the detection unit 32 determines that the first driver 18-1 is not the current driver of the vehicle 12, then at block 48, the system 10 determines, if the second driver 18-2 is the current driver of the vehicle. Likewise, by detecting whether the second remote device 14-2 is within the vehicle 12.

With continued reference to FIG. 2, as will be described in greater detail below, if it is determined that the first driver 18-1 is the current driver, then at block 50, the system 10 identifies, by the checking unit 32, if a change to the first customized user preference 36 has occurred. Likewise, if it is determined that the second driver 18-2 is the current driver, then at block 52, the system 10 identifies if a change to the second customized user preference 38 has occurred.

As set forth in more detail below, at block 54, if a change to the first customized user preference 36 has occurred, then the system 10 stores the change within the memory device 28. Likewise, at block 56, if a changed to the second customized user preference 38 has occurred, then the system 10 stores the change within the memory device 28. In some implementations, at blocks 58, 60 the system 10 synchronizes, by the synchronization unit 34, the first and second customized user preferences 36, 38 to the change stored within the memory of device 28.

As illustrated in FIG. 3, at block 64, a change to the first customized user preference 36 may be determined to have occurred if the current first customized user preference 36a is different than the last known first customized user preference 36b. In this regard, the checking unit 32, compares the current first customized user preference 36a and the last known first customized user preference 36b stored within the memory device 28. For example, if the current first customized user preference 36a is set to the enabled-state and the last known first customized user preference 36b is set to the disabled-state, then the checking unit 32 will determine that a change has occurred since these user preferences differ.

With continued reference to FIG. 3, if it is determined that a change to the first customized user preference 36 did not occur, for instance, that the current first customized user preference 36a and the last known first customized user preference 36b are equal (e.g., both are in the enabled-state or disabled-state), then, at block 66, the system 10 determines if the current second customized user preference 38 is different than the last known second customized user preference 38b. Likewise, the checking unit 32, compares the current second customized user preference 38a and the last known second customized user preference 38b stored within the memory device 28 to determine if a change has occurred to the second customized user preference 38b.

As illustrated in FIG. 3, at block 68, if it is determined that a change to the first customized user preference 36 has occurred, then the synchronization unit 34 may synchronize the current second customized user preference 38a, the last known value for the first customized user preference 36b, and the last known value for the second customized user preference 38b to be the same as the current first customized user preference 36a.

For example, if the first customized user preference 36 was changed from the disabled-state to the enabled-state, then the system 10 will synchronize the current second customized user preference 38a, the last known value for the first customized user preference 36b, and the last known value for the second customized user preference 38b to be in the enabled-state. In this regard, the control module 20 may send a write request/command or edit request/command to the memory device 28 to write/edit the current second customized user preference 38a, the last known first customized user preference 36b, and the last known second customized user preference 38b to be in the enabled-state. The updated current second customized user preference 38a, the updated last known value for the first customized user preference 36b, and the updated last known value for the second customized user preference 38b are subsequently stored in the memory device 28. For example, after the write request/command or the edit request/command is completed, the control module 20 may send a save request/command to memory device 28 to store the updated user preferences.

As illustrated in FIG. 3, at block 70, if it is determined that a change to the second customized user preference 38 has occurred, then the synchronization unit 34 may synchronize the current first customized user preference 36a, the last known value for the first customized user preference 36b, and the last known value for the second customized user preference 38b to be the same as the current second customized user preference 38a.

For example, if the second customized user preference 38 was changed from the disable-state to the enabled-state, then the system 10 will synchronize the current first customized user preference 36a, the last known value for the first customized user preference 36b, and the last known value for the second customized user preference 38b to be in the enabled-state. Likewise, the control module 20 may send a write request/command or edit request/command to the memory device 28 to write/edit the current first customized user preference 36a, the last known first customized user preference 36b, and the last known second customized user preference 38b to be in the enabled-state. The updated current first customized user preference 36a, the updated last known value for the first customized user preference 36b, and the updated last known value for the second customized user preference 38b are subsequently stored in the memory device 28. For example, after the write request/command or the edit request/command is completed, the control module 20 may send a save request/command to memory device 28 to store the updated user preferences.

In some configurations, prior to the synchronizing unit 34 being permitted to synchronize any of the foregoing customized user user preferences, the control module 20 may send a notification to the synchronizing unit 34 that the synchronization operations can began. For instance, the control module 20 may send a notification if there are no concurrent running synchronization operations or save operations involving the foregoing customized user preferences.

It should be appreciated that the steps, processes, and operations described herein are not to be construed as necessarily requiring their performance in the particular order discussed or illustrated. Accordingly, the foregoing operations may be performed in any suitable order and are not limited to the order described herein. Further, additional or alternative steps may be employed. For instance, the checking unit 32 may be configured to first identify a change in a customized user preference 36, 38 transmitted over a wireless signal and the detection unit 30 is configured to subsequently process the wireless signal to determine which of the remote devices 14 is associated with the change.

In operation, the system 10 may carry out the following scenarios as described below. In one example, the first driver's 18-1 first customized user preference 36 is set to the disabled-state. The second driver's 18-2 second customized user preference 38 is set to the disabled-state. The first driver 18-1 subsequently changes the first customized user preference 36 to the enabled-state. The system 10, by executing the foregoing operations, syncs the second customized user preference 38 to be in the enabled-state. Now both the first customized user preference 36 and the second customized user preference 38 are in the enabled-state.

In another example, the first driver's 18-1 first customized user preference 36 is set to the disabled-state. The second driver's 18-2 second customized user preference 38 is set to the enabled-state. The second driver 18-2 subsequently changes the second customized user preference 38 to the disabled-state. The system 10, by executing the foregoing operations, syncs the first customized user preference 36 to be in the disabled-state. Now both the first customized user preference 36 and the second customized user preference 38 are in the disabled-state.

In another example, the first driver's 18-1 first customized user preference 36 is set to the disabled-state. The second driver's 18-2 second customized user preference 38 is set to the disabled-state. The second driver 18-2 subsequently changes the second customized user preference 38 to the enabled-state. The system 10, by executing the foregoing operations, syncs the first customized user preference 36 to be in the enabled-state. Now both the first customized user preference 36 and the second customized user preference 38 are in the enabled-state.

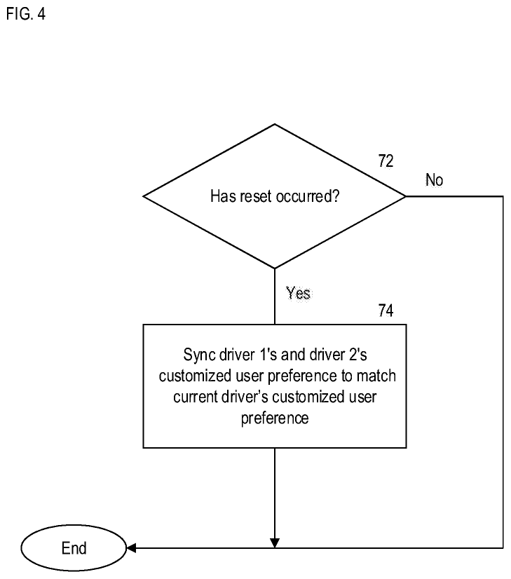

With reference to FIG. 4, a set of operations performed by the system 10 after the vehicle 12 experiences a reset condition is shown. The set of operations are performed in connection with the foregoing operations 62. In some configurations, a reset condition occurs when the vehicle 12 loses power. In particular, the reset condition may occur when the vehicle's 12 battery is disconnected from the control module 20. As illustrated in FIG. 4, at block 72, the system 10 determines if a reset has occurred. For instance, the system 10 determines when the control module 20 was disconnected from the battery, and when the control module 20 was reconnected to the battery. If the reset has occurred, following the reconnection of the power to the control module 20, the system 10 performs the operations in block 74.

For example, at block 74, the detection unit 30, as set forth above, determines if the first driver 18-1 is the current driver of the vehicle 12. If the detection unit 30 determines that the first driver 18-1 is the current driver, then the synchronization unit 34 may synch the current second customized user preference 38a, the last known first customized user preference 36b, and the last known second customized user preference 38b to be same as the current first customized user preference 36a. The updated last known value for the first customized user preference 36b, the updated last known value for the second customized preference 38b, and the updated current second customized user preference 38a are subsequently stored in the memory device 28, as set forth above.

Likewise, at block 74, if the detection unit 30 determines that the first driver 18-1 is not the current driver but the second driver 18-2 is the current driver, then the synchronization unit 34 may update the current first customized user preference 36a, the last known first customized user preference 36b, and the last known second customized user preference 38b to equal the current second customized user preference 38. The updated last known value for first customized user preference 36b, the updated last known value for the second customized user preference 38b, and the updated current first customized user preference 36a are subsequently stored in the memory device 28, as set forth above.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A system for synchronizing a changed customized user preference in a vehicle having a plurality of vehicle settings, a first remote device including a first identifier associated with a first customized user preference, and a second remote device including a second identifier associated with a second customized user preference, the system comprising:
a central processing unit (CPU) in communication with a non-volatile memory device configured to store the first customized user preference and the second customized user preference;
a detection unit in communication with the CPU and configured to determine a presence of the first identifier or the second identifier within the vehicle;
a checking unit in communication with the CPU and configured to (i) identify a change in a predetermined preference of one of the plurality of vehicle settings of the first customized user preference or the second customized user preference and (ii) store the change in the predetermined preference within the memory device; and
a synchronization unit in communication with the CPU and configured to synchronize both the first and second customized user preferences to the change in the predetermined preference stored within the memory device.

2. The system according to claim 1, wherein the checking unit is configured to determine whether the change was made to the first customized user preference.

3. The system according to claim 1, wherein the checking unit is configured to determine whether the change was made to the second customized user preference.

4. The system according to claim 1, wherein upon an occurrence of a reset condition, the synchronization unit sets the second customized user preference to the first customized user preference, if the first identifier is detected within the vehicle.

5. The system according to claim 4, wherein upon an occurrence of the reset condition, the synchronization unit sets the first customized user preference to the second customized user preference, if the second identifier is detected within the vehicle.

6. The system according to claim 5, wherein the reset condition occurs when the vehicle loses power.

7. The system according to claim 1, wherein the memory device includes an electrically erasable programmable read-only memory (EEPROM).

8. The system according to claim 1, wherein the predetermined preference is an enabled-state or a disabled-state of a locking mechanism.

9. The system according to claim 8, wherein the locking mechanism is configured to lock or unlock a bed gate of the vehicle.

10. The system according to claim 9, wherein the first and second remote devices are permitted to lock or unlock the bed gate of the vehicle when the locking mechanism is set in the enabled-state, and wherein the first and second remote devices are restricted from locking or unlocking the bed gate of the vehicle when the locking mechanism is set in the disabled-state.

11. A system for synchronizing a changed customized user preference in a vehicle having a locking mechanism, a first remote device including a first identifier associated with a first customized user preference, and a second remote device including a second identifier associated with a second customized user preference, the system comprising:
a central processing unit (CPU) in communication with a non-volatile memory device configured to store the first customized user preference and the second customized user preference;
a detection unit in communication with the CPU and configured to determine a presence of the first identifier or the second identifier within the vehicle;
a checking unit in communication with the CPU and configured to (i) identify a change to the first customized user preference or the second customized user preference and (ii) store the change within the memory device; and
a synchronization unit in communication with the CPU and configured to synchronize both the first and second customized user preferences to the change stored within the memory device, wherein the locking mechanism is configured to (i) be in an enabled-state or a disabled-state and (ii) lock or unlock a bed gate of the vehicle.

12. The system according to claim 11, wherein the checking unit is configured to determine whether the change was made to the first customized user preference.

13. The system according to claim 11, wherein the checking unit is configured to determine whether the change was made to the second customized user preference.

14. The system according to claim 11, wherein upon an occurrence of a reset condition, the synchronization unit sets the second customized user preference to the first customized user preference, if the first identifier is detected within the vehicle.

15. The system according to claim 14, wherein upon an occurrence of the reset condition, the synchronization unit sets the first customized user preference to the second customized user preference, if the second identifier is detected within the vehicle.

16. The system according to claim 15, wherein the reset condition occurs when the vehicle loses power.

17. The system according to claim 11, wherein the memory device includes an electrically erasable programmable read-only memory (EEPROM).

18. The system according to claim 11, wherein the first customized user preference and the second customized user preference are configured to set the locking mechanism in the enabled-state or the disabled-state.

19. The system according to claim 11, wherein the first and second remote devices are permitted to lock or unlock the bed gate of the vehicle when the locking mechanism is set in the enabled-state.

20. The system according to claim 19, wherein the first and second remote devices are restricted from locking or unlocking the bed gate of the vehicle when the locking mechanism is set in the disabled-state.
